(19) United States
(12) Patent Application Publication
(10) Pub. No.: US 2006/0115303 A1
(43) Pub. Date: Jun. 1, 2006

(54) Color registration sensing device, and electrophotographic image forming apparatus with the same

(75) Inventors: Il-Kwon Kang, Suwon-si (KR); Heung-sup Jeong, Suwon-si (KR); Woo-Chul Jung, (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/284,913

(22) Filed: Nov. 23, 2005

(30) Foreign Application Priority Data
Nov. 29, 2004 (KR) 2004-0098695

(51) Int. Cl. G03G 15/01

(52) U.S. Cl. 399/301

(57) ABSTRACT

Provided are a color registration sensing device to detect color registration of a color image to adjust color registration. An electrophotographic color image forming apparatus is also provided that includes a case with a door and the color registration sensing device is disposed on the case. The color registration sensing device includes at least one sensor to detect color registration of a color image, a holder including a cleaning medium which cleans the sensor while making a reciprocating movement between a first position and a second position, and an actuator to move the holder from the first position to the second position when a door of a case of an electrophotographic color image forming apparatus is closed. The holder is set to deviate from a transfer path of paper at the second position.

### CROSS-REFERENCE TO RELATED PATENT APPLICATIONS

This application claims the benefit under 35 U.S.C. 119(a) of Korean Patent Application No. 10-2004-0098695, filed on Nov. 29, 2004, the entire disclosure of which is hereby incorporated by reference.

### BACKGROUND OF THE INVENTION

1. Field of the Invention

The present invention relates to an electrophotographic color image forming apparatus that forms a color image by overlapping a plurality of different color images with one another. More particularly, the present invention relates to a color registration sensing device that detects whether color registration falls within a tolerance, and an electrophotographic color image forming apparatus with the same.

2. Description of the Related Art

In general, an electrophotographic image forming apparatus, such as a laser printer and a digital printer, prints a desired image by forming a latent image on the circumference of a photosensitive medium. The photosensitive medium is charged with a predetermined electric potential through optical scanning to develop the latent image into a visible image by supplying toner onto the latent image. Then, the visible image is transferred and fused onto paper. More specifically, the electrophotographic color image forming apparatus forms a color image by supplying toner of different colors onto the photosensitive medium, overlapping the images with one another, and transferring the result onto paper.

When images of different colors do not suitably overlap one another on the paper, the quality of the color image is degraded. For example, the outline of the color image is blurred. Thus, formation of a color image requires color registration that arranges images of different colors in the correct overlapping positions with one another on the paper. In recent years, various types of electrophotographic image forming apparatuses have been developed including an automatic color registration correcting unit and a color registration sensing unit for automatic color registration correction.

FIG. 1 is a perspective view of a conventional color registration sensing device 10 and FIG. 2 is a diagram illustrating the operation of the color registration sensing device 10. Referring to FIGS. 1 and 2, the conventional color registration sensing device 10 includes a pair of photosensors 12 fixed on a frame 9 of a color image forming apparatus (not shown). Additionally, a pair of holders 14 are implanted with brushes 17 to clean the photosensors 12. The photosensors 12 are light reflection photosensors and each includes a collimated light emitting unit (not shown) to emit light toward an upper side of a transfer belt 14. The photosensors 12 also include a light receiving unit (not shown) to receive light reflected from the transfer belt 4. The light emitting unit and the light receiving unit are installed on the same level of the photosensor 12. Each of the holders 14 is hingedly-connected to the frame 9 and is elastically biased by a spring 18.

When a door 1 of an exterior case (not shown) of the color image forming apparatus is closed, each of the holders 14 implanted with brushes 17 is pressed by a projection 2 formed on an inner side of the door 1. Thus, the brushes 17 clean the light emitting unit and the light receiving unit of the photosensor 12 while being rotated from one side to the other side. When the door 1 is open, the holder 14 is separated from the projection 2. The holder rotates from the other side to the one side due to the elasticity of the spring 18. Consequently, the photosensor 12 is cleaned again.

In color image forming apparatuses using an indirect transfer method, a color image is obtained by sequentially transferring single images. Each image is formed with different color toner onto the transfer belt 4 so that the images overlap with one another. Thus, the images are transferred as a result. In color image forming apparatuses using a direct transfer method, a color image is obtained by moving and attaching paper to the transfer belt 4 using electrostatic force. Consequently, the single images formed are transferred with different color toner onto paper and the images overlap with one another.

The color registration sensing device 10 is designed for color image forming apparatuses using the indirect transfer method. Therefore, when the color registration sensing device 10 is installed in a color image forming apparatus using the direct transfer method, a path of paper may be entirely or partially blocked by the frame 9, the photosensors 12, and the holders 14. Thus, paper jams, wrinkles, and folded corners may result.

Accordingly, there is a need to develop a color registration sensing device suitable for a color image forming apparatus using the direct transfer method.

### SUMMARY OF THE INVENTION

An aspect of the present invention is to solve at least the above problems and/or disadvantages and to provide at least the advantages described below. Accordingly, an aspect of the present invention is to provide a color registration sensing device suitable for an electrophotographic color image forming apparatus that uses a direct transfer method and is installed so that it does not deviate from a path of paper and block the movement of paper during printing of an image.

According to one aspect of the present invention, there is provided a color registration sensing device including at least one sensor to detect color registration of a color image. A holder is also provided having a cleaning medium to clean the sensor while making a reciprocating movement between a first position and a second position. An actuator is also provided to move the holder from the first position to the second position when a door of a case of an electrophotographic color image forming apparatus is closed. The holder is set to deviate from a transfer path of paper at the second position.

The actuator may be integrally connected with the holder. The holder may also be configured to pivot around and rotate when the actuator moves linearly.

A pivot axis of the holder may be parallel to a virtual line extending in a width direction of the color image.

A slot may be formed on a side of the holder which is spaced from the pivot axis. The actuator may comprise a projection to connect the actuator with the holder when the projection is inserted into the slot.

The actuator may be elastically biased to return the holder to the first position.

The sensor may be hidden by the holder at the first position and exposed from the holder at the second position.

The sensor may be a photosensor.

The number of sensors may be two to detect color registration of both ends of the color image widthwise.

The cleaning medium may be a brush implanted on the holder.

According to another aspect of the present invention, there is provided an electrophotographic color image forming apparatus which includes a case with a door, and a color registration sensing device for color registration detection. The color registration sensing device comprises at least one sensor to detect color registration of a color image. A holder is also provided and includes a cleaning medium to clean the sensor while making a reciprocating movement between a first position and a second position and an actuator to move the holder from the first position to the second position when the door of the case is closed. The holder is set to deviate from a transfer path of paper at the second position.

The actuator may be integrally connected with the holder, and the holder may be configured to pivot around and rotate when the actuator moves linearly.

A pivot axis of the holder may be parallel to a virtual line extending in a width direction of the color image.

A slot may be formed on a side of the holder which is spaced from the pivot axis. The actuator may comprise a projection to connect the actuator with the holder when the projection is inserted into the slot.

The actuator may be elastically biased to return the holder to the first position.

The sensor may be hidden by the holder at the first position and exposed from the holder at the second position.

The sensor may be a photosensor.

The number of sensors may be two to sense color registration of both ends of the color image widthwise.

The cleaning medium may be a brush implanted on the holder.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a perspective view of a conventional color registration sensing device;

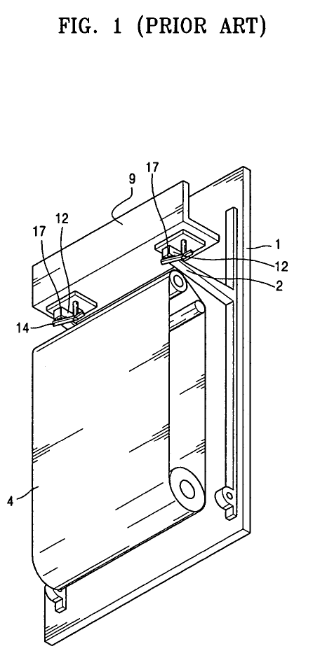

FIG. 2 is a diagram illustrating the operation of the color registration sensing device of FIG. 1;

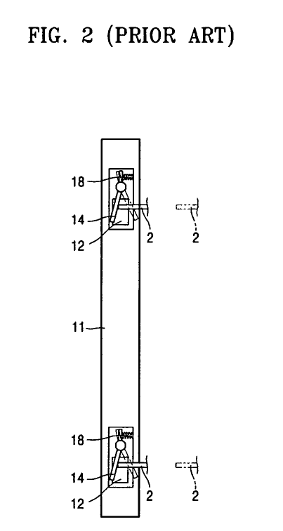

FIG. 3 is a cross-sectional view of an electrophotographic color image forming apparatus in accordance with an embodiment of the present invention;

FIG. 4 is a perspective view of a color registration sensing device according in accordance with an embodiment of the present invention; and

FIGS. 5 and 6 are cross-sectional views illustrating the operation of the color registration sensing device of FIG. 4.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity conciseness.

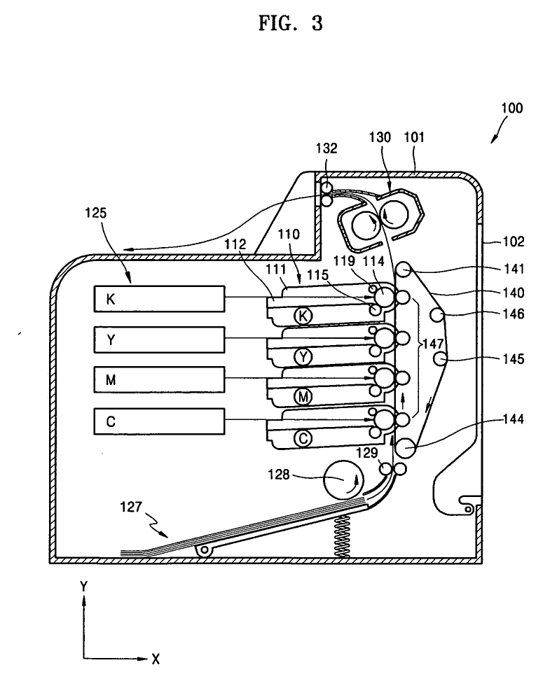

Referring to FIG. 3, an electrophotographic color image forming apparatus 100 according to an embodiment of the present invention uses a direct transfer method in which a color image is formed by sequentially transferring toner images of different colors onto paper and overlapping the toner images with one another. The electrophotographic color image forming apparatus 100 includes a case 101; developing units 110C, 110M, 110Y, and 110K which are installed on the case 101; four light scanning units 125C 125M, 125Y, and 126K; a transfer belt 140; four transfer rollers 147; and a fusing unit 130. Also, the electrophotographic color image forming apparatus 100 includes a cassette 127 on which paper is stacked, a pickup roller 128 to pick up a sheet of paper from the cassette 127, a feed roller 129 to feed the pickup paper, and an exit roller 132 to facilitate driving paper printed with an image to the outside of the case 101.

The developing units 110C, 110M, 110Y, and 110K are cartridge types that must be replaced with new ones when a developing solution such as toner is consumed. Referring to FIG. 3, the electrophotographic color image forming apparatus 100 includes the developing units 110C, 110M, 110Y, and 110K that contain toner of different colors, such as, cyan (C), magenta (M), yellow (Y), and black (K), respectively.

When a door 102 formed on a side of the case 101 is opened, the transfer belt 140 lies laterally. Thus, allowing exchange of the developing units 110C, 110M, 110Y, and 110K is allowed when toner is consumed. The transfer belt 140 circulates lengthwise, while being supported by a driving roller 141. The driving roller 141 is connected to a motor (not shown) through first, second, and third support rollers 144, 145, and 146.

The light scanning units 125C, 125M, 125Y, and 125K correspond to the developing units 110C, 110M, 110Y, and 110K. The light scanning units 125C, 125M, 125Y, and 125K scan lights corresponding to information regarding C, M, Y, and K images onto photosensitive media 114C, 114M, 114Y, and 114K installed on housings 111C, 111M, 111Y, and 111K of the developing units 110C, 110M, 110Y, and 110K, respectively. The light scanning units 125C, 125M, 125Y, and 125K are preferably laser scanning units (LSUs) that use a laser diode as a light source.

The photosensitive media 114C, 114M, 114Y, and 114K, and developing rollers 115C, 115M, 115Y, and 115K are installed on the housings 111C, 111M, 111Y, and 111K, respectively. For transfer of an image, a part of each of the photosensitive media 114C, 114M, 114Y, and 114K, which face the transfer belt 140, are exposed from each of the housings 110C, 110M, 110Y, and 110K. Also, the developing units 110C, 110M, 110Y, and 110K, include charging rollers 119C, 119M, 119Y, and 119K, respectively. A charging bias is applied to the charging rollers 119C, 119M, 119Y, and 119K to charge the circumferences of the photosensitive media 114C, 114M, 114Y, and 114K with an electric potential.

The circumferences of the developing rollers 115C, 115M, 115Y, and 115K are attached with toner. When a developing bias is applied to the developing rollers 115C, 115M, 115Y, and 115K, the toner attached to the circumferences thereof is supplied to the photosensitive media 114C, 114M, 114Y, and 114K, respectively. Although not shown in the drawings, each of the housings 111C, 111M, 111Y, and 111K further includes a supply roller that supplies the toner to each of the developing rollers 115C, 115M, 115Y, and 115K. A doctor blade controls the amount of toner attached to each of the developing rollers 115C, 115M, 115Y, and 115K. An agitator, preferably of the belt conveyor type, transfers the toner in each of the housings 111C, 111M, 111Y, and 111K onto the supply roller. Apertures 112C, 112M, 112Y, and 112K are respectively formed on the developing units 110C, 110M, 110Y, and 110K, through which lights, which are scanned by the light scanning units 125C, 125M, 125Y, and 125K, are scanned onto the photosensitive media 114C, 114M, 114Y, and 114K.

The four transfer rollers 147 respectively face the photosensitive media 114C, 114M, 114Y, and 114K. The four transfer rollers 147 are also installed between the transfer belt 140 and the photosensitive media 114C, 114M, 114Y, and 114K. A transfer bias is applied to the transfer belt 147.

The method of obtaining a color image in an electrophotographic color image forming apparatus in accordance with an embodiment of the present invention will now be described.

When a charging bias is applied to the charging rollers 119C, 119M, 119Y, and 119K, the photosensitive media 114C, 114M, 114Y, and 114K are charged with an electric potential. The light scanning units 125C, 125M, 125Y, and 125K scan lights corresponding to information regarding C, M, Y, and K images onto the photosensitive media 114C, 114M, 114Y, and 114K through the apertures 112C, 112M, 112Y, and 112K. Thus, a latent image is formed on each of the circumferences of the photosensitive media 114C, 114M, 114Y, and 114K, respectively. When a developing bias is applied to the developing rollers 115C, 115M, 115Y, and 115K, toner attached to the developing rollers 115C, 115M, 115Y, and 115K is transferred onto the circumferences of the photosensitive media 114C, 114M, 114Y, and 114K. Consequently, C, M, Y, and K visual images are developed along the circumferences of the photosensitive media 114C, 114M, 114Y, and 114K, respectively.

A sheet of paper is picked up from the cassette 127 by the pickup roller 128 and fed to the transfer belt 140 through the feed roller 129. The paper is attached to the transfer belt 140 due to electrostatic force, and moved at a speed equivalent to the linear movement speed of the transfer belt 140.

The tip of the moving paper attached to the transfer belt 140 reaches a transfer nip between the photosensitive medium 114C and its corresponding transfer roller 147. So, when the tip of the visual image on the circumference of the photosensitive medium 114C reaches the transfer nip, a transfer bias is applied to the corresponding transfer roller 147 and the C visual image is transferred onto the paper. Similarly, the M, Y, and K visual images formed on the circumferences of the photosensitive media 114M, 114Y, and 114K are sequentially transferred onto the paper and overlap with the C visual image. Thus, a color image is formed on the paper. Next, when the fusing unit 130 applies heat and pressure onto the color image, the color image is fused with the paper. Thereafter, the paper is discharged outside the case 101 through the exit roller 132.

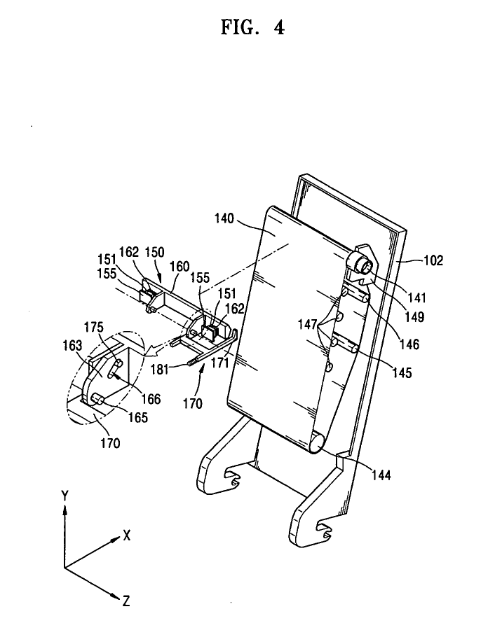

Referring to FIGS. 4 through 6, a color registration sensing device 150 is installed on the color image forming apparatus 100 of FIG. 3. The color registration sensing device 150 includes a pair of sensors 151 that detect color registration of a color image, a holder 160 implanted with a pair of brushes 162 as cleaning media for cleaning the sensors 151, and an actuator 170 connected to the holder 160 to rotate the holder 160.

Each of the sensors 151 is a light reflection photosensor that includes a light emitting unit (not shown) and a light receiving unit (not shown) on a sensing side 152. When the door 102 of the case 101 of FIG. 3 is closed, the light emitting unit is collimated to emit light toward the transfer belt 140 positioned ahead of the light emitting unit in an X-axis direction. The light receiving unit receives the light reflected from the transfer belt 140. The sensors 151 are fixed by frames 155 in the case 101. The color registration sensing device 150 includes two photosensors 151, each facing a corresponding side of the transfer belt 140. This is because color registration of both ends of a color image widthwise may be different from each other due to scan skews of the light scanning units 125C, 125M, 125Y, and 125K of FIG. 3.

The holder 160 is installed on the case 101 and rotates with respect to a predetermined pivot axis 165. Referring to FIG. 4, the holder 160 is elongated in a Z direction. The holder 160 is a resin molding member united with a holder body 161. An inner side of the holder 160 is implanted with the brush 162. A holder arm 163 is connected along the pivot axis 165. The pivot axis 165 is parallel to a virtual line extending in the Z direction that is also a width direction of the color image.

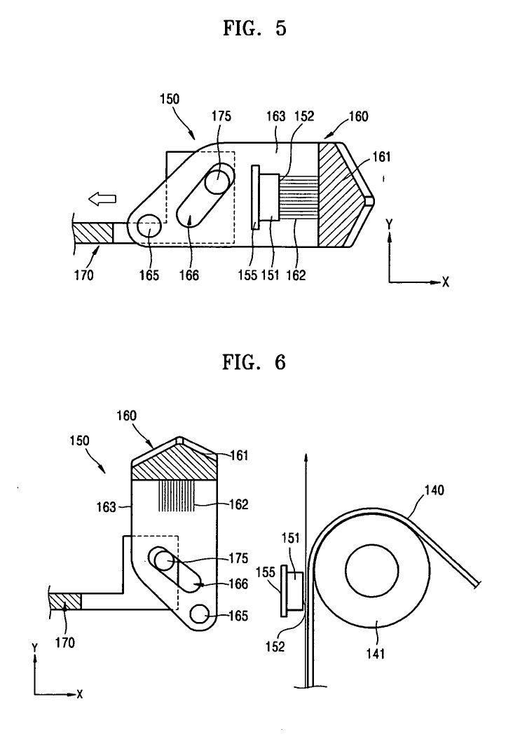

The holder 160 rotates with respect to the pivot axis 165, and makes a reciprocating movement between a first position and a second position. Referring to FIG. 5, when the holder 160 is present at the first position, the light emitting unit and the light receiving unit of each of the photosensors 151 are hidden by the holder 160. Referring to FIG. 6, when holder 160 is present at the second position, the light emitting unit and the light receiving unit of each of the photosensors 151 are exposed from the holder 160. A slot 166 is formed in the holder arm 163, through which the holder arm 163 is combined with the actuator 170.

The actuator 170 includes a receiver 171 to deviate from a transfer path of paper and a projection 175. When the projection 175 is inserted into the slot 166, the holder 160 is combined with the actuator 170. When the door 102 is closed, the receiver 171 is pressed by a bushing 149 covering an end portion of the driving roller 141 to drive and supports the transfer belt 140. Thus, the actuator 170 linearly moves backward in the X-axis direction. Thus, the projection 175 puts torque onto the holder arm 163 while moving backward in the X-axis direction. Moreover, the holder body 161 moves from the first position to the second position while being rotated counterclockwise. The actuator 170 is elastically biased by the spring 181. As a result, the receiver 171 projects forward in the X-axis direction. Therefore, when the door 102 is open, the actuator 170 returns to the first position due to the elasticity of the spring 181, and the holder 160 combined with the actuator 170 also returns to the first position.

Referring to FIG. 5, when the holder 160 is present at the first position, the sensing side 152 of the photosensor 151 is hidden by the holder body 161 and the brush 162. Accordingly, when the door 102 is open, it is possible to prevent the photosensor 151 from being contaminated or damaged due to user error.

Referring to FIG. 6, when the door 102 is closed, the brush 162 sweeps and cleans dust or foreign substances from the sensing side 152 while the holder body 161 is moving to the second position. At the second position, the holder body 161 may deviate slightly from a transfer path of paper. The deviation is indicated by an arrow marked beside the transfer belt 140. Therefore, the color registration sensing device 150 prevents paper jams or a corner of the paper from being folded during printing of an image on the paper.

The electrophotographic color image forming apparatus 100 is set to stop a print job and detect color registration of a color image after performing the print job on predetermined number of sheets of paper. Specifically, the light scanning units 125C, 125M, 125Y, and 125K form test single images of four colors by scanning test lights on the photosensitive media 114C, 114M, 114Y, and 114K and developing the results of scanning, respectively. The test single images are sequentially transferred onto the transfer belt 140 to overlap with one another. Thus, a test color image is formed. Next, the photosensors 151 detect the test color image to determine whether color registration of the color image falls within a predetermined tolerance.

If the color registration falls within the predetermined tolerance, image printing is suspended, enabling color registration detection to restart. If the color registration does not fall within the predetermined tolerance, the light scanning units 125C, 125M, 125Y, and 125K are controlled to adjust the color registration. Thus, image printing is restarted.

As described above, a color registration sensing device installed in an electrophotographic color image forming apparatus according to embodiments of the present invention prevents paper jams or a corner of the paper from being folded, while deviating slightly from a transfer path of paper.

Also, when a door of the electrophotographic color image forming apparatus is open, a sensor is hidden, thereby preventing the sensor from being contaminated or damaged.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A color registration sensing device comprising:
at least one sensor detecting color registration of a color image;
a holder including a cleaning medium to clean the sensor, and the holder being configured to clean the sensor while making a reciprocating movement between a first position and a second position; and
an actuator configured to move the holder from the first position to the second position when a door of a case of an electrophotographic color image forming apparatus is closed,
wherein the holder is set to deviate from a transfer path of paper at the second position.

2. The color registration sensing device of claim 1, wherein the actuator is integrally connected to the holder, and
the holder is arranged to pivot around and rotate when the actuator moves linearly.

3. The color registration sensing device of claim 2, wherein a pivot axis of the holder is parallel to a virtual line extending in a width direction of the color image.

4. The color registration sensing device of claim 2, wherein a slot is formed on a side of the holder which is spaced from the pivot axis, and
the actuator comprises a projection to connect the actuator with the holder when the projection is inserted into the slot.

5. The color registration sensing device of claim 1, wherein the actuator is elastically biased to return the holder to the first position.

6. The color registration sensing device of claim 1, wherein the sensor is hidden by the holder at the first position, and exposed from the holder at the second position.

7. The color registration sensing device of claim 1, wherein the sensor is a photosensor.

8. The color registration sensing device of claim 1, wherein the number of sensors is two to detect color registration of both ends of the color image widthwise.

9. The color registration sensing device of claim 1, wherein the cleaning medium is a brush implanted on the holder.

10. An electrophotographic color image forming apparatus which includes a case with a door, and a color registration sensing device for color registration detection, wherein the color registration sensing device comprises:
at least one sensor sensing color registration of a color image;
a holder including a cleaning medium to clean the sensor while making a reciprocating movement between a first position and a second position; and
an actuator configured to move the holder from the first position to the second position when the door of the case is closed,
wherein the holder is set to deviate from a transfer path of paper at the second position.

11. The electrophotographic color image forming apparatus of claim 10, wherein the actuator is integrally connected to the holder, and
the holder is installed to pivot around and rotate when the actuator moves linearly.

12. The electrophotographic color image forming apparatus of claim 11, wherein a pivot axis of the holder is parallel to a virtual line extending in a width direction of the color image.

13. The electrophotographic color image forming apparatus of claim 11, wherein a slot is formed on a side of the holder which is spaced from the pivot axis, and
the actuator comprises a projection to connect the actuator with the holder when the projection is inserted into the slot.

14. The electrophotographic color image forming apparatus of claim 10, wherein the actuator is elastically biased to return the holder to the first position.

15. The electrophotographic color image forming apparatus of claim 10, wherein the sensor is hidden by the holder at the first position and exposed from the holder at the second position.

16. The electrophotographic color image forming apparatus of claim 10, wherein the sensor is a photosensor.

17. The electrophotographic color image forming apparatus of claim 10, wherein the number of sensors is two to detect color registration of both ends of the color image widthwise.

18. The electrophotographic color image forming apparatus of claim 10, wherein the cleaning medium is a brush implanted on the holder.
